(19) United States
(12) Patent Application Publication
(10) Pub. No.: US 2025/0293400 A1
(43) Pub. Date: Sep. 18, 2025

(54) STORAGE CELL

(71) Applicants: TOYOTA JIDOSHA KABUSHIKI KAISHA, Toyota-shi (JP); TOYOTA BATTERY CO., LTD., Kosai (JP)

(72) Inventors: Masato ONO, Nagoya-shi (JP); Masahiro ISHIZUKA, Toyota-shi (JP); Atsushi SUGIHARA, Toyota-shi (JP); Yuka YOKOI, Nagoya-shi (JP); Ryosuke SATO, Toyota-shi (JP); Keitaro MACHIDA, Hamamatsu-shi (JP); Tatsuya YAMAMOTO, Toyohashi-shi (JP)

(73) Assignees: TOYOTA JIDOSHA KABUSHIKI KAISHA, Toyota-shi (JP); TOYOTA BATTERY CO., LTD., Kosai (JP)

(21) Appl. No.: 19/052,516

(22) Filed: Feb. 13, 2025

(30) Foreign Application Priority Data
Mar. 18, 2024 (JP) 2024-042042

(51) Int. Cl. H01M 50/474; H01M 50/103; H01M 50/538

(52) U.S. Cl. CPC H01M 50/474; H01M 50/103; H01M 50/538

(57) ABSTRACT

A storage cell includes a first cell unit group including a plurality of first cell units, and a second cell unit group including a plurality of second cell units. Each of the cell units includes an electrode body, a laminate exterior body, a positive electrode current collector terminal, and a negative electrode current collector terminal. The pair of first cell units has a first connection portion, and the pair of second cell units has a second connection portion. In the first cell unit group, the first connection portions are arranged along the first direction so as to be located alternately up and down. In the second cell unit group, the second connection portions are arranged along the first direction so as to be located alternately up and down and so as not to overlap with the first connection portions respectively in the second direction.

### CROSS-REFERENCE TO RELATED APPLICATION

This application claims priority to Japanese Patent Application No. 2024-042042 filed on Mar. 18, 2024, incorporated herein by reference in its entirety.

### BACKGROUND

### 1. Technical Field

The disclosure relates to a storage cell.

### 2. Description of Related Art

For example, Japanese Unexamined Patent Application Publication (Translation of PCT application) No. 2023-509216 (JP 2023-509216 A) discloses a battery equipped with a first electrode body set including a plurality of electrode bodies connected in series to one another along a first direction, and a second electrode body set including a plurality of electrode bodies connected in series to one another along the first direction. The second electrode body set is adjacent to the first electrode body set in a second direction orthogonal to both the first direction and an up-and-down direction.

In the first electrode body set, electrode lead members of a pair of adjacent electrode bodies are connected to each other by a first connection member. In the second electrode body set, electrode lead members of a pair of adjacent electrode bodies are also connected to each other by the first connection member. In the first electrode body set, each first connection member is provided on a lower portion of each electrode body, and in the second electrode body set, each first connection member is provided on an upper portion of each electrode body.

### SUMMARY

In the battery described in JP 2023-509216 A, the stability of each electrode body set is low. For example, with respect to the respective electrode bodies in the first electrode body set, the upper portions of the electrode bodies are likely to rotate with respect to the lower portions of the electrode bodies around a rotating axis which is an axis connecting a plurality of first connection members arranged side by side along the first direction.

An object of the present disclosure is to provide a storage cell that is capable of enhancing the stability of each cell unit.

A storage cell according to one aspect of the present disclosure includes a first cell unit group including a plurality of first cell units arranged side by side in a first direction, and a second cell unit group that includes a plurality of second cell units arranged side by side in the first direction, and is arranged so as to be adjacent to the first cell unit group in a second direction orthogonal to both the first direction and an up-and-down direction, wherein each of the first cell units and the second cell units includes an electrode body, a laminate exterior body that accommodates the electrode body, a positive electrode current collector terminal protruding from a portion of the laminate exterior body that is located on one side of the laminate exterior body in the first direction and on one side of the laminate exterior body in the up-and-down direction, and a negative electrode current collector terminal protruding from a portion of the laminate exterior body that is located on the other side of the laminate exterior body in the first direction and on the other side of the laminate exterior body in the up-and-down direction, and wherein a pair of first cell units adjacent to each other in the first direction has a first connection portion in which the positive electrode current collector terminal of one first cell unit in the pair of first cell units is connected to the negative electrode current collector terminal of the other first cell unit in the pair of the first cell units, a pair of second cell units adjacent to each other in the first direction has a second connection portion in which the positive electrode current collector terminal of one second cell unit in the pair of second cell units is connected to the negative electrode current collector terminal of the other second cell unit in the pair of the second cell units, in the first cell unit group, the first connection portions are arranged along the first direction so as to be located alternately up and down, and in the second cell unit group, the second connection portions are arranged along the first direction so as to be located alternately up and down and so as not to overlap with the first connection portions respectively in the second direction.

According to the present disclosure, it is possible to provide a storage cell that can improve the stability of each cell unit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view that schematically shows a storage cell according to an embodiment of the present disclosure;

FIG. 2 is a perspective view of a first cell unit group and a second cell unit group;

FIG. 3 is a front view that schematically shows a part of the storage cell;

FIG. 4 is a sectional view taken along line IV-IV in FIG. 3; and

FIG. 5 is a diagram that schematically shows a modification of a connection member.

### DETAILED DESCRIPTION OF EMBODIMENTS

An embodiment of the present disclosure will be described with reference to the drawings. In the drawings to be referred to below, the same or corresponding components are designated by the same reference numerals.

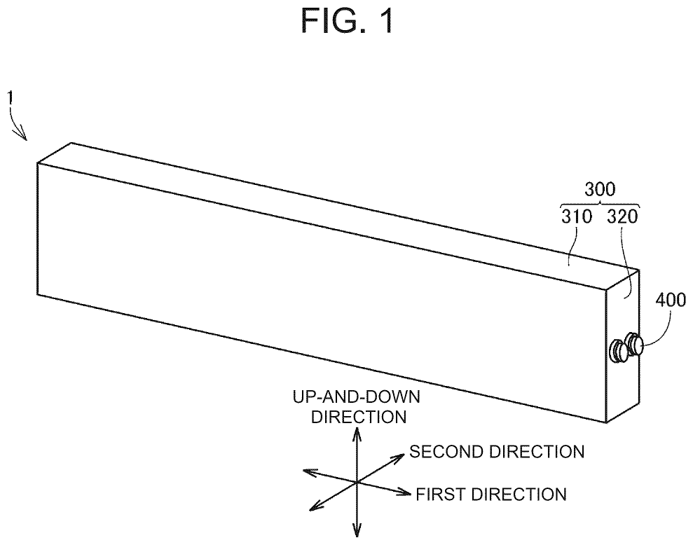

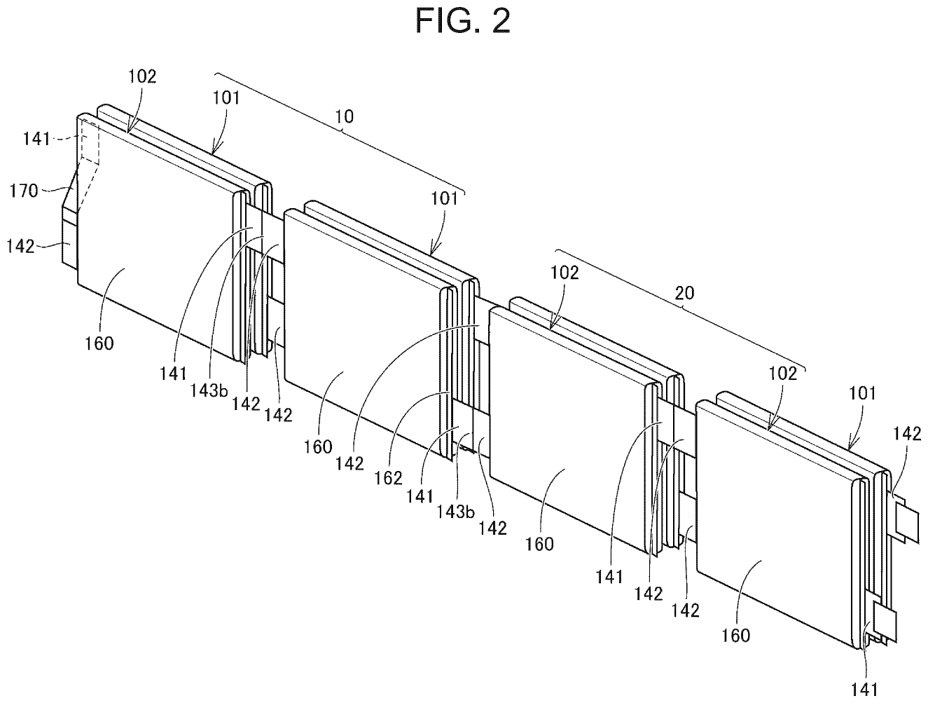

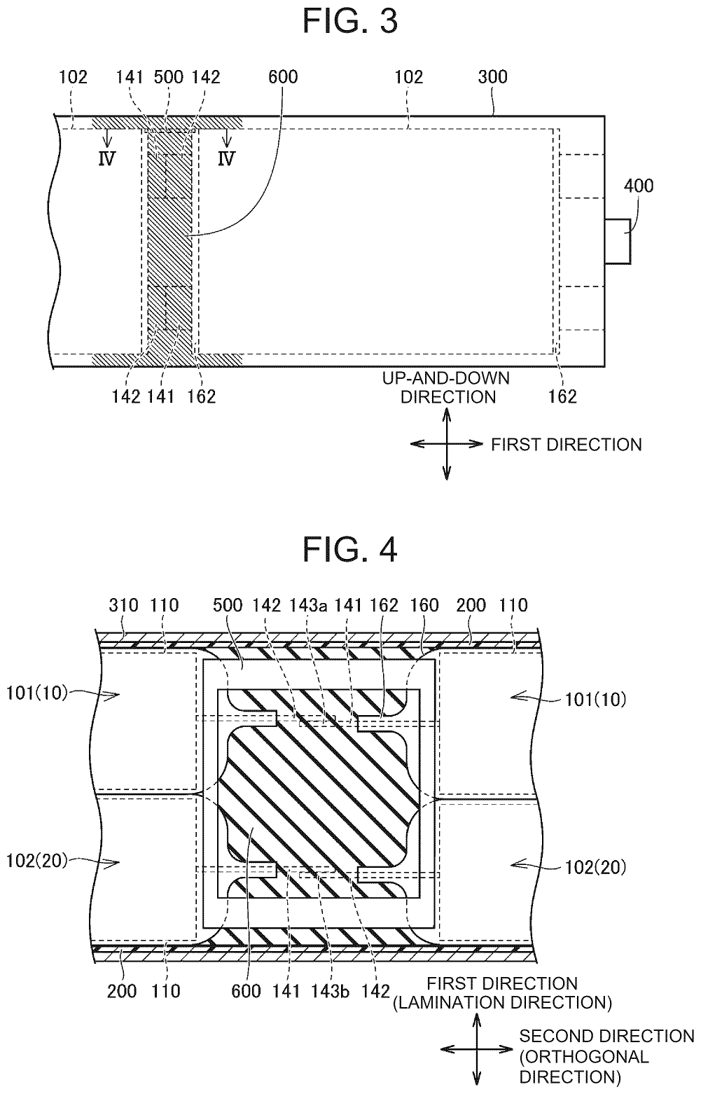

FIG. 1 is a perspective view that schematically shows a storage cell according to an embodiment of the present disclosure. FIG. 2 is a perspective view of a first cell unit group and a second cell unit group shown in FIG. 1. FIG. 3 is a front view that schematically shows a part of the storage cell. FIG. 4 is a sectional view taken along line IV-IV in FIG. 3. This storage cell 1 is mounted, for example, on a bottom portion of a vehicle.

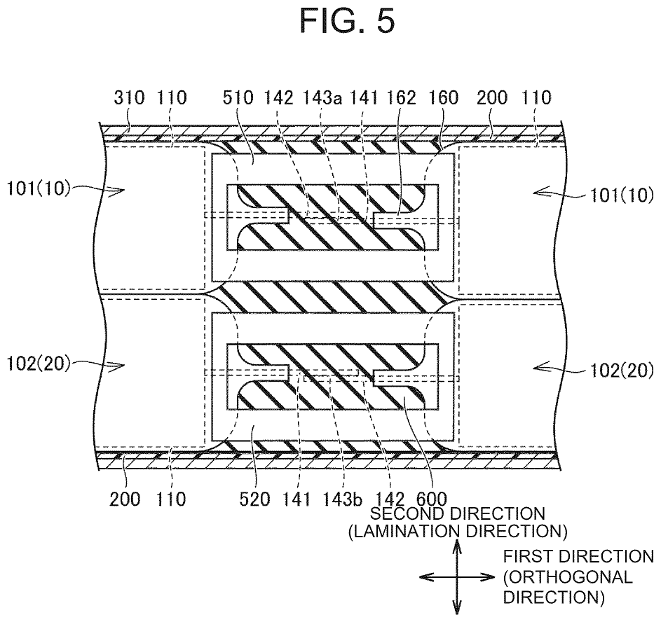

As shown in FIG. 1 to FIG. 4, the storage cell 1 includes a first cell unit group 10, a second cell unit group 20, a coating sheet 200 (see FIGS. 4 and 5), a cell case 300, an external terminal 400, connection members 500, and coating members 600. Note that the coating sheet 200 is omitted from the illustration in FIG. 2.

The first cell unit group 10 includes a plurality of first cell units 101. In the present embodiment, the first cell unit group 10 includes four first cell units 101. However, the number of the first cell units 101 is not limited to four. The first cell units 101 are arranged side by side along a first direction. A pair of first cell units 101 adjacent to each other in the first direction are connected to each other.

The second cell unit group 20 includes a plurality of second cell units 102. In the present embodiment, the second cell unit group 20 includes four second cell units 102. However, the number of second cell units 102 is not limited to four. The second cell units 102 are arranged side by side along the first direction. A pair of second cell units 102 adjacent to each other in the first direction are connected to each other. The second cell unit group 20 is arranged so as to be adjacent to the first cell unit group 10 in a second direction which is orthogonal to both the first direction and an up-and-down direction.

The cell units 101, 102 have the same structure. Examples of each of the cell units 101, 102 include a lithium ion battery. Each of the cell units 101, 102 may be configured by a so-called all-solid-state battery including a solid electrolyte.

Each of the cell units 101, 102 has a shape that extends to be longer in the first direction than in the second direction and longer in the first direction than in the up-and-down direction. Each of the cell units 101, 102 has a shape that extends to be longer in the up-and-down direction than in the second direction.

Each of the cell units 101, 102 includes an electrode body 110, a positive electrode current collector terminal 141, a negative electrode current collector terminal 142, and a laminate exterior body 160.

The electrode body 110 is configured by a wound body in which a positive electrode sheet and a negative electrode sheet are wound with a separator interposed therebetween. However, the electrode body 110 may be configured by a laminate in which a positive electrode sheet and a negative electrode sheet are laminated with a separator interposed therebetween. The electrode body 110 is formed in a shape which is longer in an orthogonal direction that is orthogonal to both a lamination direction and the up-and-down direction. The lamination direction corresponds to the second direction, and the orthogonal direction corresponds to the first direction.

A positive electrode current collector terminal 141 is connected to the electrode body 110. The positive electrode current collector terminal 141 is made of, for example, aluminum. The positive electrode current collector terminal 141 protrudes in the first direction from a portion of the electrode body 110 which is located on one side of the electrode body 110 in the first direction and on one side of the electrode body 110 in the up-and-down direction.

A negative electrode current collector terminal 142 is connected to the electrode body 110. The negative electrode current collector terminal 142 is made of, for example, copper. The negative electrode current collector terminal 142 protrudes in the first direction from a portion of the electrode body 110 which is located on the other side of the electrode body 110 in the first direction and on the other side of the electrode body 110 in the up-and-down direction.

The laminate exterior body 160 accommodates the electrode body 110 and a part of each of the current collector terminals 141, 142. The laminate exterior body 160 is made of a laminate film. As shown in FIG. 2 to FIG. 4, the laminate exterior body 160 has an edge portion 162. The edge portion 162 is formed by connecting (welding) laminate films to each other.

Each of the current collector terminals 141, 142 protrudes from an edge portion 162 of the laminate exterior body 160. The positive electrode current collector terminal 141 protrudes from a portion of the laminate exterior body 160 which is located on one side of the laminate exterior body 160 in the first direction and on one side of the laminate exterior body 160 in the up-and-down direction. The negative electrode current collector terminal 142 protrudes from a portion of the laminate exterior body 160 which is located on the other side of the laminate exterior body 160 in the first direction and on the other side of the laminate exterior body 160 in the up-and-down direction.

As shown in FIG. 2, the positive electrode current collector terminal 141 of the first cell unit 101 arranged at an end portion in the first direction is connected to the negative electrode current collector terminal 142 of the second cell unit adjacent to the first cell unit 101 in the second direction via a bus bar 170.

As shown in FIG. 4, a pair of first cell units 101 adjacent to each other in the first direction has a first connection portion 143a in which the positive electrode current collector terminal 141 of one first cell unit 101 is connected to the negative electrode current collector terminal 142 of the other first cell unit 101. As shown in FIG. 2, in the first cell unit group 10, the first connection portions 143a are arranged side by side along the first direction so as to be located alternately up and down.

As shown in FIG. 4, a pair of second cell units 102 adjacent to each other in the first direction has a second connection portion 143b in which the positive electrode current collector terminal 141 of one second cell unit 102 is connected to the negative electrode current collector terminal 142 of the other second cell unit 102. As shown in FIG. 2, in the second cell unit group 20, the second connection portions 143b are arranged side by side along the first direction so as to be located alternately up and down and so as not to overlap with the first connection portions 143a in the second direction.

The coating sheet 200 (see FIG. 4) covers the first cell unit group 10 and the second cell unit group 20 so as to collectively surround these cell unit groups 10, 20. The coating sheet 200 is made of an insulating material (synthetic resin or the like).

The cell case 300 accommodates each of the cell unit groups 10, 20 and the coating sheet 200. The cell case 300 is made of, for example, aluminum. The cell case 300 is formed in a rectangular parallelepiped shape that is elongated in the first direction. As shown in FIG. 1, the cell case 300 has a case body 310 and a lid 320.

The case body 310 is formed in a rectangular tubular shape elongated in the first direction. The case body 310 surrounds each of the cell unit groups 10, 20 and the coating sheet 200.

The lid 320 is connected to the case body 310 by welding or the like so as to block an opening of the case body 310.

The external terminal 400 is provided on the lid 320. The external terminal 400 is connected to the current collector terminals of the cell units 101, 102 which are located at the closest positions to the lid 320 in the first cell unit group 10 and the second cell unit group 20.

The connection member 500 connects a pair of first cell units 101 adjacent to each other in the first direction, and also connects a pair of second cell units 102 adjacent to each other in the first direction. Specifically, the connection member 500 connects a pair of first cell units 101 adjacent to each other in the first direction so as to restrict the pair of first cell units 101 from displacing relatively to each other in the second direction, and connects the pair of second cell units 102 adjacent to each other in the first direction so as to restrict the pair of second cell units 102 from displacing relatively to each other in the second direction. Note that the connection member 500 is omitted from the illustration in FIG. 2.

As shown in FIG. 3 and FIG. 4, the connection member 500 is provided on the upper portion of each of the cell units 101, 102. Specifically, the connection member 500 spans the upper portions of a pair of first cell units 101 adjacent to each other in the first direction, and spans the upper portions of a pair of second cell units 102 adjacent to each other in the first direction. The connection member 500 is formed in a flattened rectangular tubular shape. As shown in FIG. 3, the upper surface of the connection member 500 may be located at the same position as the upper end portion of each of the cell units 101, 102 or to be slightly lower than the position. The connection member 500 is made of, for example, a synthetic resin.

The coating member 600 covers each first connection portion 143a and each second connection portion 143b. The coating member 600 is made of an insulating material. In the present embodiment, the coating member 600 is made of an adhesive member having an insulating property. The coating member 600 may be connected to the cell case 300. For example, as shown in FIG. 3, the coating member 600 may bond the lower portion of each of the cell units 101, 102 to the cell case 300. Similarly, the coating member 600 may bond the upper portion of each of the cell units 101, 102 to the cell case 300.

As described above, in the storage cell 1 of the present embodiment, a plurality of first connection portions 143a and a plurality of second connection portions 143b are arranged along the first direction so as to be located alternately up and down, so that one first cell unit 101 of a pair of adjacent first cell units 101 is prevented from rotating around the first connection portion 143a relatively to the other first cell unit 101, and one second cell unit 102 of a pair of adjacent second cell units 102 is prevented from rotating around the second connection portion 143b relatively to the other second cell unit 102. As a result, the stability of each of the cell units 101, 102 is enhanced. Furthermore, since the second connection portions 143b are arranged side by side so as not to overlap with the first connection portions 143a in the second direction, occurrence of a short circuit caused by the contact between the first connection portion 143a and the second connection portion 143b is restrained.

As shown in FIG. 5, the connection member 500 may have a first member 510 and a second member 520.

The first member 510 connects a pair of first cell units 101 adjacent to each other in the first direction. The first member 510 spans the upper portions of the pair of first cell units 101 adjacent to each other in the first direction.

The second member 520 connects a pair of second cell units 102 adjacent to each other in the first direction. The second member 520 spans the upper portions of the pair of second cell units 102 adjacent to each other in the first direction.

It will be understood by those skilled in the art that the exemplary embodiment described above is a specific example of the following aspect.

### Aspect 1

A storage cell includes:
a first cell unit group including a plurality of first cell units arranged side by side in a first direction; and
a second cell unit group that includes a plurality of second cell units arranged side by side in the first direction, and is arranged so as to be adjacent to the first cell unit group in a second direction orthogonal to both the first direction and an up-and-down direction, wherein each of the first cell units and the second cell units includes:
an electrode body;
a laminate exterior body that accommodates the electrode body;
a positive electrode current collector terminal protruding from a portion of the laminate exterior body that is located on one side of the laminate exterior body in the first direction and on one side of the laminate exterior body in the up-and-down direction; and
a negative electrode current collector terminal protruding from a portion of the laminate exterior body that is located on the other side of the laminate exterior body in the first direction and on the other side of the laminate exterior body in the up-and-down direction, and
   wherein:
a pair of first cell units adjacent to each other in the first direction has a first connection portion in which the positive electrode current collector terminal of one first cell unit in the pair of first cell units is connected to the negative electrode current collector terminal of the other first cell unit in the pair of the first cell units;
a pair of second cell units adjacent to each other in the first direction has a second connection portion in which the positive electrode current collector terminal of one second cell unit in the pair of second cell units is connected to the negative electrode current collector terminal of the other second cell unit in the pair of the second cell units;
in the first cell unit group, the first connection portions are arranged along the first direction so as to be located alternately up and down; and
in the second cell unit group, the second connection portions are arranged along the first direction so as to be located alternately up and down and so as not to overlap with the first connection portions respectively in the second direction.

In this storage cell, the first connection portions and the second connection portions are arranged along the first direction so as to be located alternately up and down, so that one first cell unit of the pair of first cell units adjacent to each other is restrained from rotating around the first connection portion relatively to the other first cell unit, and one second cell unit of the pair of second cell units adjacent to each other is restrained from rotating around the second connection portion relatively to the other second cell unit. Therefore, the stability of each cell unit is enhanced. Furthermore, since the respective second connection portions are arranged side by side so as not to overlap with the respective first connection portions in the second direction, occurrence of a short circuit caused by the contact between the first connection portions and the second connection portions is restrained.

### Aspect 2

The storage cell according to the aspect 1 further includes a connection member that connects the pair of first cell units adjacent to each other in the first direction to each other so as to restrict the pair of first cell units from displacing relatively to each other in the second direction, and connects the pair of second cell units adjacent to each other in the first direction to each other so as to restrict the pair of second cell units from displacing relatively to each other in the second direction.

In this aspect, the relative displacement in the second direction between the pair of adjacent first cell units and the relative displacement in the second direction between the pair of adjacent second cell units are restricted. Therefore, exfoliation of the first connection portion and the second connection portion is restrained.

### Aspect 3

The storage cell according to the aspect 1 or 2 further includes a coating member that is made of an insulating material and coats each of the first connection portions and each of the second connection portions.

In this aspect, occurrence of a short circuit caused by the first connection portion coming into contact with the second connection portion is restrained.

### Aspect 4

The storage cell according to the aspect 3 further includes a cell case that accommodates the first cell unit group and the second cell unit group, wherein the coating member is made of an insulating adhesive member, and is connected to the cell case.

In this aspect, the relative displacement of each cell unit group with respect to the cell case is restrained, so that stresses occurring at the connection portion between the first cell units and the connection portion between the second cell units are reduced.

Note that the embodiment disclosed herein is illustrative in all respects and should not be considered to be limited. The scope of the present disclosure is indicated by the claims rather than the description of the embodiment, and further includes all modifications within the scope of the claims and meanings equivalent to the scope of the claims.

What is claimed is:

1. A storage cell comprising:
a first cell unit group including a plurality of first cell units arranged side by side in a first direction; and
a second cell unit group that includes a plurality of second cell units arranged side by side in the first direction, and is arranged so as to be adjacent to the first cell unit group in a second direction orthogonal to both the first direction and an up-and-down direction, wherein each of the first cell units and the second cell units comprises:
an electrode body;
a laminate exterior body that accommodates the electrode body;
a positive electrode current collector terminal protruding from a portion of the laminate exterior body that is located on one side of the laminate exterior body in the first direction and on one side of the laminate exterior body in the up-and-down direction; and
a negative electrode current collector terminal protruding from a portion of the laminate exterior body that is located on the other side of the laminate exterior body in the first direction and on the other side of the laminate exterior body in the up-and-down direction, and wherein:
a pair of first cell units adjacent to each other in the first direction has a first connection portion in which the positive electrode current collector terminal of one first cell unit in the pair of first cell units is connected to the negative electrode current collector terminal of the other first cell unit in the pair of the first cell units;
a pair of second cell units adjacent to each other in the first direction has a second connection portion in which the positive electrode current collector terminal of one second cell unit in the pair of second cell units is connected to the negative electrode current collector terminal of the other second cell unit in the pair of the second cell units;
in the first cell unit group, the first connection portions are arranged along the first direction so as to be located alternately up and down; and
in the second cell unit group, the second connection portions are arranged along the first direction so as to be located alternately up and down and so as not to overlap with the first connection portions respectively in the second direction.

2. The storage cell according to claim 1, further comprising a connection member that connects the pair of first cell units adjacent to each other in the first direction to each other so as to restrict the pair of first cell units from displacing relatively to each other in the second direction, and connects the pair of second cell units adjacent to each other in the first direction to each other so as to restrict the pair of second cell units from displacing relatively to each other in the second direction.

3. The storage cell according to claim 2, further comprising a coating member that is made of an insulating material and coats each of the first connection portions and each of the second connection portions.

4. The storage cell according to claim 3, further comprising a cell case that accommodates the first cell unit group and the second cell unit group, wherein the coating member is made of an insulating adhesive member, and is connected to the cell case.
